(19) United States
(12) Patent Application Publication
(10) Pub. No.: US 2017/0334453 A1
(43) Pub. Date: Nov. 23, 2017

(54) VEHICLE CONTROL SYSTEM, VEHICLE CONTROL METHOD, AND VEHICLE CONTROL PROGRAM PRODUCT

(71) Applicant: Honda Motor Co., Ltd., Tokyo (JP)

(72) Inventors: Yoshitaka MIMURA, Saitama (JP); Kohei OKIMOTO, Saitama (JP); Naotaka KUMAKIRI, Saitama (JP)

(73) Assignee: Honda Motor Co., Ltd., Tokyo (JP)

(21) Appl. No.: 15/598,320

(22) Filed: May 18, 2017

(30) Foreign Application Priority Data
May 18, 2016 (JP) 2016-099341

(51) Int. Cl. B60W 50/08; B60W 30/18; G05D 1/00; B60W 10/20; B60W 50/14; B60W 30/12; B60W 50/00

(52) U.S. Cl. CPC B60W 50/082; B60W 10/20; B60W 30/18; B60W 50/14; G05D 1/0077; G05D 1/0088; B60W 2050/0072; B60W 30/12; B60W 2050/146; B60W 2420/52; B60W 2550/402; B60W 2710/20; B60W 2720/10; B60W 2420/42

(57) ABSTRACT

To prompt smooth takeover of driving behavior of a driver, a vehicle control system includes a driving state information acquisition unit that acquires driving state information indicating a state of automatic driving regarding at least one of steering and acceleration/deceleration when a transition from automatic driving to manual driving occurs, a requested operation information generation unit that generates requested operation information indicating operation information that is requested to a vehicle occupant when the transition from automatic driving to manual driving occurs on the basis of the driving state information acquired by the driving state information acquisition unit, and a requested operation information notification unit that issues a notification to the vehicle occupant on the basis of the requested operation information generated by the requested operation information generation unit.

### CROSS-REFERENCE TO RELATED APPLICATION

This application claims the priority benefit of Japan application serial no. 2016-099341, filed on May 18, 2016. The entirety of the above-mentioned patent application is hereby incorporated by reference herein and made a part of this specification.

### BACKGROUND OF THE INVENTION

### Field of the Invention

The present invention relates to a vehicle control system, a vehicle control method, and a vehicle control program product.

### Description of Related Art

In recent years, research on a technology (hereinafter, referred to as “automatic driving”) for automatically controlling at least one of steering and acceleration/deceleration of a host vehicle so that the host vehicle travels along a route to a destination has been conducted.

In connection with this, a driving support device includes a display means for displaying a steering direction or a steering amount of a steering wheel, an accelerator operation amount, and the like so that a vehicle occupant can always recognize these during automatic driving.

For example, in a driving support device disclosed in Japanese Unexamined Patent Application Publication No. 2014-164466, an order or a time of turning on a plurality of lighting units mounted in an upper portion of a steering wheel is changed, causing a vehicle occupant to recognize a steering direction or a steering speed of the steering wheel. Further, for example, in the driving support device disclosed in Japanese Unexamined Patent Application Publication No. 2014-164466, colors of light emitted from the lighting unit mounted at a center of the steering wheel are distinguished, causing the vehicle occupant to recognize whether accelerator pedal is depressed or a brake pedal is depressed.

### SUMMARY OF THE INVENTION

In automatic driving, for example, when a host vehicle is traveling on a curve, the host vehicle is in a state of being steered. When the automatic driving ends at this time (that is, when switching from automatic driving to manual driving is performed), there is a likelihood of driving behavior being unable to be smoothly taken over if the vehicle occupant grips portions of the steering wheel at positions (for example, positions of 3 o'clock and 9 o'clock) of the steering wheel at which the vehicle occupant grips at the time of straight traveling.

Further, in automatic driving, for example, when the host vehicle is traveling on an uphill slope, the host vehicle is in a state in which an acceleration request is made. When the handover is performed at this time, there is a likelihood of driving behavior being unable to be smoothly taken over if the vehicle occupant places his or her foot on a brake pedal. Similarly, for example, when the host vehicle is traveling on a downhill slope, the host vehicle is a state in which a deceleration request is made. When the automatic driving ends at this time, there is a likelihood of the driving behavior being unable to be smoothly taken over if the vehicle occupant places his or her foot on an accelerator pedal.

Therefore, when the automatic driving ends, it is preferable that the vehicle occupant grips the steering wheel according to a steering angle of the steering wheel and correctly places the foot on the depressed accelerator pedal or brake pedal. However, for example, in a case in which the inside of the vehicle is dark at night or the like, it may be difficult for the vehicle occupant to recognize a state of the steering angle of the steering wheel or a state in which the accelerator pedal or the brake pedal is depressed.

When the automatic driving ends, it is necessary for delivery of driving behavior from a vehicle control system responsible for automatic driving to a vehicle occupant (hereinafter referred to as “handover”) to be performed smoothly and performed safely. However, according to a driving support device described in Japanese Unexamined Patent Application Publication No. 2014-164466, it is necessary for the vehicle occupant to perform a determination regarding a position at which the steering wheel is to be gripped or perform a determination regarding which of the accelerator pedal or the brake pedal the foot is to be placed, on the basis of an order or a time in which a lighting unit mounted in the steering wheel emits light, and color of the light, and then, to take over the driving behavior from the vehicle control system. Therefore, there is a problem in that a driver cannot smoothly take over the driving behavior on the basis of an intuitive determination.

The present invention has been made in view of such circumstances, and an object thereof is to provide a vehicle control system, a vehicle control method, and a vehicle control program capable of prompting a driver smooth takeover of driving behavior of a driver.

(1) The present invention has been made to solve the above problems and an aspect of the present invention is a vehicle control system, including: a driving state information acquisition unit that acquires driving state information indicating a state of automatic driving regarding at least one of steering and acceleration/deceleration when a transition from automatic driving to manual driving occurs; a requested operation information generation unit that generates requested operation information indicating operation information that is requested to a vehicle occupant when the transition from automatic driving to manual driving occurs on the basis of the driving state information acquired by the driving state information acquisition unit; and a requested operation information notification unit that issues a notification to the vehicle occupant on the basis of the requested operation information generated by the requested operation information generation unit.

(2) Further, an aspect of the present invention is the vehicle control system according to (1), wherein the driving state information acquisition unit acquires a state of automatic driving regarding steering, and the requested operation infomiation notification unit displays a position at which the steering wheel is to be gripped on the basis of the state of the automatic driving regarding the steering.

(3) Further, an aspect of the present invention is the vehicle control system according to (1) or (2), wherein the driving state information acquisition unit acquires a state of automatic driving regarding steering, and the requested operation information notification unit performs display regarding an operation force of the steering wheel on the basis of the state of the automatic driving regarding the steering.

(4) Further, an aspect of the present invention is the vehicle control system according to any one of (1) to (3), wherein the driving state information acquisition unit acquires a state of automatic driving regarding acceleration and deceleration, and the requested operation information notification unit performs display showing a pedal of which an operation is requested, on the basis of the state of the automatic driving regarding the acceleration and deceleration.

(5) Further, an aspect of the present invention is the vehicle control system according to any one of (1) to (4), wherein the driving state information acquisition unit acquires a state of automatic driving regarding acceleration and deceleration, and the requested operation information notification unit performs display showing an operation force of a pedal on the basis of the state of the automatic driving regarding the acceleration and deceleration.

(6) Further, an aspect of the present invention is a vehicle control method using a computer, the method including: a driving state information acquisition step of acquiring, by a driving state information acquisition unit, driving state information indicating a state of automatic driving regarding at least one of steering and acceleration/deceleration when a transition from automatic driving to manual driving occurs; a requested operation information generation step of generating, by a requested operation information generation unit, requested operation information indicating operation information that is requested by a vehicle occupant when the transition from automatic driving to manual driving occurs on the basis of the driving state information acquired by the driving state information acquisition unit; and a requested operation information notification step of issuing, by a requested operation information generation unit, a notification to the vehicle occupant on the basis of the requested operation information generated by the requested operation information generation unit.

Further, an aspect of the present invention is a vehicle control program product comprising a computer usable medium having control logic stored therein for causing a computer to execute: a driving state information acquisition step of acquiring driving state information indicating a state of automatic driving regarding at least one of steering and acceleration/deceleration when a transition from automatic driving to manual driving occurs; a requested operation information generation step of generating requested operation information indicating operation information that is requested by a vehicle occupant when the transition from automatic driving to manual driving occurs on the basis of the driving state information acquired in the driving state information acquisition step; and a requested operation information notification step of issuing a notification to the vehicle occupant on the basis of the requested operation information generated in the requested operation information generation step.

According to the invention defined in aspects (1), (6), and (7), it is possible to prompt smooth takeover of driving behavior of the driver.

Further, according to the invention defined in aspect (2), it is possible to intuitively recognize a position at which the steering wheel is to be gripped.

Further, according to the invention defined in aspect (3), it is possible to recognize a state in which a specific force is applied to the steering wheel (an operation force of the steering wheel).

Further, according to the invention defined in aspect (4), it is possible to intuitively recognize whether a foot is placed on the accelerator pedal or the foot is placed on the brake pedal.

Further, according to the invention defined in aspect (5), it is possible to intuitively recognize a specific depression amount or depression force (operation force) with which the accelerator pedal or the brake pedal is to be depressed.

### BRIEF DESCRIPTION OF THE DRAWINGS

FIG. 1 is a diagram illustrating components of a host vehicle (M).

FIG. 2 is a functional configuration diagram focusing on a vehicle control system (100) of the host vehicle (M).

FIG. 3 is a configuration diagram of functions of a driving operation system and a non-driving operation system of an HMI (70).

FIG. 4 is a diagram illustrating a state in which a relative position of a host vehicle (M) with respect to a travel lane (L1) is recognized by a vehicle position recognition unit (140).

FIG. 5 is a diagram illustrating an example of an action plan generated for a certain section.

FIG. 6 is a diagram illustrating an example of a configuration of a trajectory generation unit (146).

FIG. 7 is a diagram illustrating an example of candidates for a trajectory generated by a trajectory candidate generation unit (146B).

FIG. 8 is a diagram in which candidates for the trajectory generated by the trajectory candidate generation unit (146B) are represented by trajectory points (K).

FIG. 9 is a diagram illustrating a lane change target position (TA).

FIG. 10 is a diagram illustrating a speed generation model when speeds of three surrounding vehicles are assumed to be constant.

FIG. 11(A) to FIG. 11(C) are a diagram illustrating an example of notification of a driving operation for steering using a requested operation information notification unit (98a) to a vehicle occupant.

FIG. 12 is a flowchart illustrating an operation of notification of a driving operation for steering using an HMI (70) to a vehicle occupant.

FIG. 13 is a diagram illustrating another example of notification of a driving operation for steering using a requested operation infoiivation notification unit (98a) to a vehicle occupant.

FIG. 14 is a configuration diagram of a function of a driving operation system of the HMI (70).

FIG. 15 is a diagram illustrating an example of notification of a driving operation for acceleration and deceleration using a requested operation information notification unit (98b) and a requested operation information notification unit (98c) to a vehicle occupant.

FIG. 16 is a configuration diagram of a function of a driving operation system of the HMI (70).

FIG. 17 is a diagram illustrating an example of notification of a driving operation for acceleration and deceleration using a display device (82) to a vehicle occupant.

FIG. 18 is a diagram illustrating another example of notification of a driving operation for acceleration and deceleration using the display device (82) to the vehicle occupant.

### DETAILED DESCRIPTION OF THE INVENTION

Hereinafter, embodiments of a vehicle control system, a vehicle control method, and a vehicle control program of the present invention will be described with reference to the drawings.

<Common Configuration>

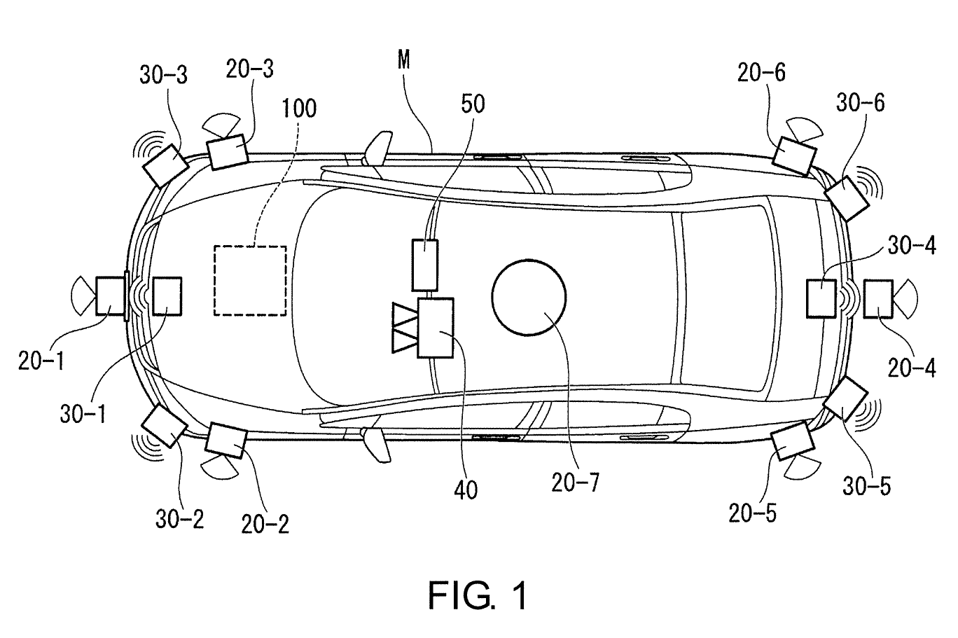

FIG. 1 is a diagram illustrating components of a vehicle on which a vehicle control system 100 of each embodiment is mounted (hereinafter referred to as a host vehicle M). The vehicle on which the vehicle control system 100 is mounted is, for example, a two-wheeled, three-wheeled, or four-wheeled car, and includes a car including an internal combustion engine such as a diesel engine or a gasoline engine as a power source, an electric car including an electric motor as a power source, a hybrid car including both of an internal combustion engine and an electric motor, or the like. The electric car, for example, is driven using electric power discharged by a battery, such as a secondary battery, a hydrogen fuel cell, a metal fuel cell, or an alcohol fuel cell.

As illustrated in FIG. 1, sensors such as finders 20-1 to 20-7, radars 30-1 to 30-6, and a camera 40, a navigation device 50, and the vehicle control system 100 are mounted on the host vehicle M.

The finders 20-1 to 20-7 are, for example, LIDARs (light detection and ranging or laser maging detection and ranging) that measure scattered light with respect to irradiation light and measure a distance to a target. For example, the finder 20-1 is attached to a front grille or the like, and the finders 20-2 and 20-3 are attached to a side of a vehicle body, a side view mirror, the inside of a headlamp, the vicinity of a side lamp, or the like. The finder 20-4 is attached to a trunk lid or the like, and the finders 20-5 and 20-6 are attached to, for example, a side of a vehicle body or the inside of a tail light. The finders 20-1 to 20-6 described above have, for example, a detection region of about 150° with respect to a horizontal direction. Further, the finder 20-7 is attached to a roof or the like. The finder 20-7 has, for example, a detection region of 360° with respect to a horizontal direction.

The radars 30-1 and 30-4 are, for example, long-distance millimeter wave radars having a detection region in a depth direction wider than the other radars. Further, the radars 30-2, 30-3, 30-5, and 30-6 may be intermediate-distance millimeter wave radars having a detection region in a depth direction narrower than the radars 30-1 and 30-4.

Hereinafter, when the finders 20-1 to 20-7 are not particularly distinguished, the finders 20-1 to 20-7 are simply described as “finders 20”, and when the radars 30-1 to 30-6 are not particularly distinguished, the radars 30-1 to 30-6 are simply described as “radars 30.” The radars 30 detect, for example, an object using a frequency modulated continuous wave (FM-CW) scheme.

The camera 40 is, for example, a digital camera using a solid-state imaging element such as a charge coupled device (CCD) or a complementary metal oxide semiconductor (CMOS). The camera 40 is attached to an upper portion of a front windshield, a back surface of an interior mirror, or the like. The camera 40 repeatedly images periodically, for example, in front of the host vehicle M. The camera 40 may be a stereo camera including a plurality of cameras.

The configuration illustrated in FIG. 1 is merely an example, and parts of the configuration may be omitted or other configurations may be added.

### First Embodiment

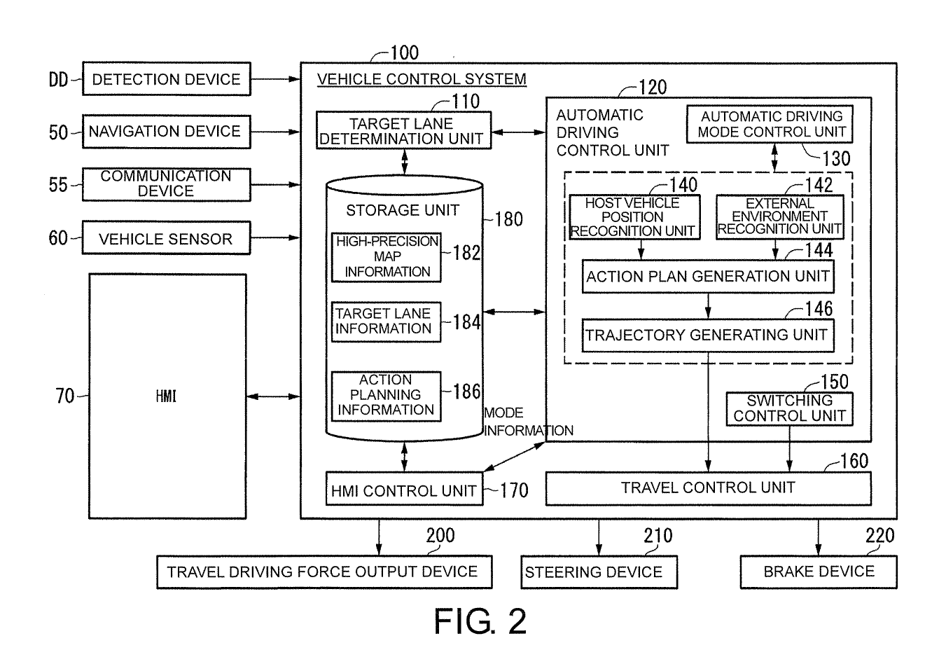

FIG. 2 is a functional configuration diagram focusing on the vehicle control system 100 according to a first embodiment. A detection device DD including a finder 20, a radar 30, a camera 40, or the like, a navigation device 50, a communication device 55, a vehicle sensor 60, a human machine interface (HMI) 70, a vehicle control system 100, a travel driving force output device 200, a steering device 210, and a brake device 220 are mounted on a host vehicle M. These apparatus or devices are connected to each other by a multiplex communication line such as a controller area network (CAN) communication line, a serial communication line, a wireless communication network, or the like. A vehicle control system in the claims does not indicate only the “vehicle control system 100” and may include a configuration (for example, the detection device DD and the HMI 70) other than the vehicle control system 100.

The navigation device 50 includes, for example, a global navigation satellite system (GNSS) receiver or map information (navigation map), a touch panel display device functioning as a user interface, a speaker, and a microphone. The navigation device 50 specifies a position of the host vehicle M using the GNSS receiver, and derives a route from the position to a destination designated by a user. The route derived by the navigation device 50 is provided to a target lane determination unit 110 of the vehicle control system 100. The position of the host vehicle M may be specified or complemented by an inertial navigation system (INS) using the output of the vehicle sensors 60. Further, the navigation device 50 performs guidance through sound or navigation display with respect to the route to the destination. A configuration for specifying the position of the host vehicle M may be provided independently of the navigation device 50. Further, the navigation device 50 may be realized by, for example, a function of a terminal device such as a smartphone or a tablet terminal owned by the user. In this case, transmission and reception of information are performed by wireless or wired communication between the terminal device and the vehicle control system 100.

The communication device 55 performs, for example, wireless communication using a cellular network, a Wi-Fi network, Bluetooth (registered trademark), dedicated short range communication (DSRC), or the like.

The vehicle sensors 60 include a vehicle speed sensor that detects a vehicle speed, an acceleration sensor that detects an acceleration, a yaw rate sensor that detects an angular velocity around a vertical axis, an azimuth sensor that detects a direction of the host vehicle M, and the like.

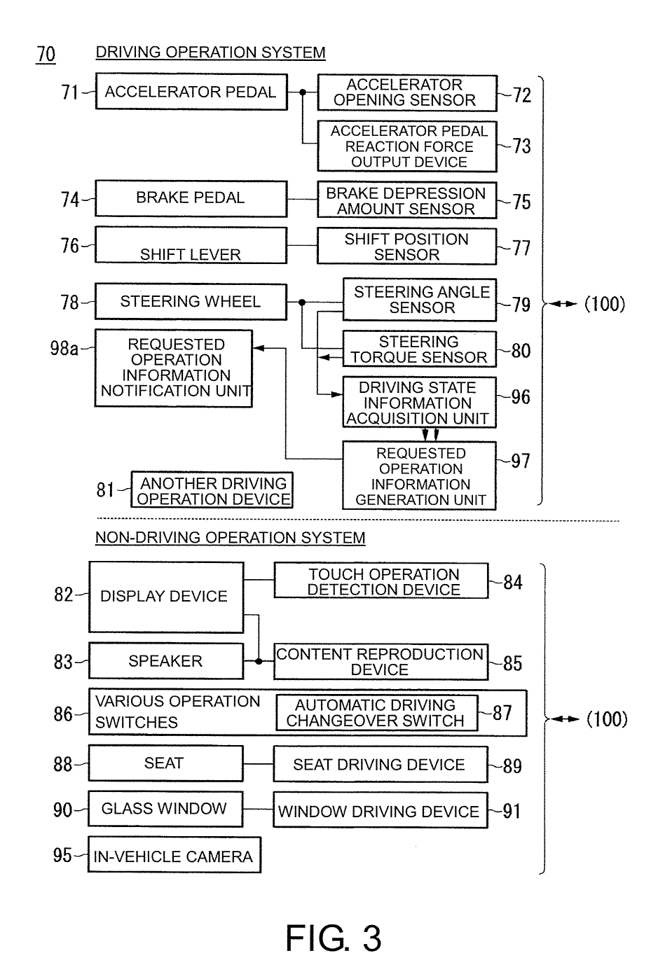

FIG. 3 is a configuration diagram of the HMI 70. The HMI 70 includes, for example, a configuration of a driving operation system, and a configuration of a non-driving operation system. A boundary therebetween is not clear, and the configuration of the driving operation system may include a function of the non-driving operation system (or vice versa).

Further, as described above, the vehicle control system in the claims does not indicate only the “vehicle control system 100” and may include, for example, the HMI 70 that is a configuration other than the vehicle control system 100.

The HMI 70 includes, for example, an accelerator pedal 71, an accelerator opening sensor 72, an accelerator pedal reaction force output device 73, a brake pedal 74, a brake depression amount sensor (or, for example, a master pressure sensor) 75, a shift lever 76, a shift position sensor 77, a steering wheel 78, a steering angle sensor 79, a steering torque sensor 80, another driving operation device 81, a driving state infonnation acquisition unit 96, a requested operation information generation unit 97, and a requested operation information notification unit 98a, as the configuration of the driving operation system.

The accelerator pedal 71 is an operator for receiving an acceleration instruction from the vehicle occupant (or a deceleration instruction by a return operation). The accelerator opening sensor 72 detects a depression amount or a depression force (operation force) of the accelerator pedal 71, and outputs an accelerator opening signal indicating the depression amount or a depression force (operation force) to the vehicle control system 100. In place of the accelerator opening signal being output to the vehicle control system 100, the accelerator opening signal may be directly output to the travel driving force output device 200, the steering device 210, or the brake device 220. The same applies to the configuration of another driving operation system to be described below. The accelerator pedal reaction force output device 73 outputs a force (operation reaction force) in a direction opposite to an operation direction to the accelerator pedal 71, for example, according to an instruction from the vehicle control system 100.

The brake pedal 74 is an operator for receiving a deceleration instruction from the vehicle occupant. The brake depression amount sensor 75 detects a depression amount or a depression force (operation force) of the brake pedal 74, and outputs a brake signal indicating a result of the detection to the vehicle control system 100.

The shift lever 76 is an operator for receiving an instruction to change a shift stage from the vehicle occupant. The shift position sensor 77 detects the shift stage instructed by the vehicle occupant, and outputs a shift position signal indicating a result of the detection to the vehicle control system 100.

The steering wheel 78 is an operator for receiving a turning instruction from the vehicle occupant. The steering wheel 78 includes a requested operation information notification unit 98a to be described below. The steering angle sensor 79 detects a steering angle of the steering wheel 78, and outputs a steering angle signal indicating a result of the detection to the vehicle control system 100. The steering torque sensor 80 detects a torque applied to the steering wheel 78, and outputs a steering torque signal indicating a result of the detection to the vehicle control system 100.

The other driving operation device 81 is, for example, a joystick, a button, a dial switch, a graphical user interface (GUI) switch, or the like. The other driving operation device 81 receives an acceleration instruction, a deceleration instruction, a turning instruction, or the like and outputs the instruction to the vehicle control system 100.

The driving state information acquisition unit 96 acquires driving state information indicating a state of automatic driving regarding steering of the vehicle on the basis of performance of a handover event which is an event indicating a transition from automatic driving to manual driving in driving control of the vehicle.

Specifically, for example, if the handover event included in action plan information 186 created by an action plan generation unit 144 and stored in a storage unit 180 is performed by an automatic driving control unit 120, information indicating the handover event is output to the driving state information acquisition unit 96 of the HMI 70 via an HMI control unit 170. If the information indicating the handover event is input, the driving state information acquisition unit 96 acquires the driving state information indicating a state of automatic driving regarding steering of the vehicle. The driving state information is, for example, information including the steering angle signal acquired from the steering angle sensor 79 and the steering torque signal acquired from the steering torque sensor 80. According to the by-wire technology or the like, the state of the operation device (for example, a state of a steering angle and a steering torque) and a control state regarding steering in automatic driving may not match. The driving state information acquisition unit 96 outputs the acquired driving state information to the requested operation information generation unit 97.

The handover event may be performed on the basis of the operation of an automatic driving changeover switch 87 to be described below.

The requested operation information generation unit 97 generates requested operation information indicating a notification for causing the transition from automatic driving to manual driving to be smooth on the basis of the driving state information input from the driving state information acquisition unit 96.

Specifically, the requested operation information generation unit 97 generates, for example, requested operation information indicating a notification for causing the transition from automatic driving to manual driving to be smooth on the basis of the steering angle signal or the steering torque signal included in the input driving state information. The requested operation information includes, for example, one or a plurality of pieces of information among information indicating the requested operation information notification unit 98a that emits light among a plurality of requested operation information notification units 98a to be described below, information indicating the color of the light emitted by the requested operation information notification unit 98a, information indicating whether the light emitted by the requested operation information notification unit 98a is caused to blink, information indicating a blinking interval of the light emitted by the requested operation information notification unit 98a, and information indicating an order or a timing of light emission of the plurality of requested operation information notification units 98a.

The requested operation information generation unit 97 outputs the generated requested operation information to the requested operation information notification unit 98a.

The requested operation information notification unit 98a issues a notification for causing the transition from automatic driving to manual driving to be smoothly performed to the vehicle occupant on the basis of the requested operation information generated by the requested operation information generation unit 97.

Specifically, the requested operation information notification unit 98a is included in the steering wheel. The requested operation information notification unit 98a performs, for example, at least one of light emission and display for notifying the vehicle occupant of a position at which the steering wheel is to be gripped on the basis of the requested operation information input from the requested operation information generation unit 97. Further, the requested operation information notification unit 98a performs, for example, at least one of light emission and display for notifying the vehicle occupant of a torque to be applied to a steering wheel (an operation force of the steering wheel) on the basis of the requested operation information input from the requested operation information generation unit 97.

The HMI 70 includes, for example, a display device 82, a speaker 83, a touch operation detection device 84, a content reproduction device 85, various operation switches 86, a seat 88, a seat driving device 89, a glass window 90, a window driving device 91, and an in-vehicle camera 95, as the configuration of the non-driving operation system.

The display device 82 is, for example, a liquid crystal display (LCD), an organic electroluminescence (EL) display device, or the like, which is attached to each portion of an instrument panel, at a central portion of the steering wheel, or at an arbitrary place facing a passenger seat or a rear seat. Further, the display device 82 may be a head-up display (HUD) that projects an image onto a front windshield or another window. The speaker 83 outputs sound. When the display device 82 is a touch panel, the touch operation detection device 84 detects a touch position in a display screen of the display device 82 and outputs the touch position to the vehicle control system 100. When the display device 82 is not a touch panel, the touch operation detection device 84 may be omitted.

The content reproduction device 85 includes, for example, a digital versatile disc (DVD) reproduction device, a compact disc (CD) reproduction device, a television receiver, or a device that generates various guidance images. The display device 82, the speaker 83, the touch operation detection device 84, and the content reproduction device 85 may be partially or entirely configured in common with the navigation device 50.

The various operation switches 86 are arranged at arbitrary places in the vehicle. The various operation switches 86 include an automatic driving changeover switch 87 that instructs starting (or future starting) and stopping of automatic driving. The automatic driving changeover switch 87 may be any one of a graphical user interface (GUI) switch and a mechanical switch. Further, the various operation switches 86 may include a switch for driving the seat driving device 89 or the window driving device 91.

The seat 88 is a seat on which the vehicle occupant sits. The seat driving device 89 freely drives a reclining angle of the seat 88, a position in frontward and backward directions, a yaw angle, or the like. A glass window 90 is provided in, for example, each door. The window driving device 91 drives the glass window 90 such that the glass window 90 opens or closes.

The in-vehicle camera 95 is a digital camera using a solid-state imaging element such as a CCD or CMOS. The in-vehicle camera 95 is attached at a position at which at least a head of the vehicle occupant who performs a driving operation can be imaged, such as a rearview mirror, a steering boss portion, or an instrument panel. The camera 40, for example, repeatedly images the vehicle occupant periodically.

The travel driving force output device 200, the steering device 210, and the brake device 220 will be described prior to the description of the vehicle control system 100.

The travel driving force output device 200 outputs a travel driving force (torque) for a traveling vehicle to driving wheels. When the host vehicle M is a car using an internal combustion engine as a power source, the travel driving force output device 200 includes, for example, an engine, a transmission, and an engine electronic control unit (ECU) for controlling the engine. When the host vehicle M is an electric car using an electric motor as a power source, the travel driving force output device 200 includes a travel motor, and a motor ECU that controls the travel motor. When the host vehicle M is a hybrid car, the travel driving force output device 200 includes an engine, a transmission, an engine ECU, a travel motor, and a motor ECU. When the travel driving force output device 200 includes only an engine, the engine ECU adjusts a throttle opening, a shift stage, or the like of the engine according to the information input from a travel control unit 160 to be described below. When the travel driving force output device 200 includes only a travel motor, the motor ECU adjusts a duty ratio of a PWM signal to be applied to the travel motor according to the information input from the travel control unit 160. When the travel driving force output device 200 includes an engine and a travel motor, the engine ECU and the motor ECU control the travel driving force in cooperation with each other according to the information input from the travel control unit 160.

The steering device 210 includes, for example, a steering ECU and an electric motor. The electric motor, for example, applies a force to a rack and pinion mechanism to change an orientation of a steering wheel. The steering ECU drives the electric motor according to the information input from the vehicle control system 100, the input steering angle or steering torque information to change the orientation of the steering wheel.

The brake device 220 is, for example, an electric servo brake device including a brake caliper, a cylinder that transfers hydraulic pressure to the brake caliper, an electric motor that generates hydraulic pressure in the cylinder, and a brake control unit. The brake control unit of the electric servo brake device controls the electric motor according to the information input from the travel control unit 160 so that a brake torque according to a brake operation is output to each wheel. The electric servo brake device may include, as a backup, a mechanism that transfers the hydraulic pressure generated by an operation of the brake pedal to the cylinder via a master cylinder. The brake device 220 is not limited to the electric servo brake device described above, and may be an electronically controlled hydraulic brake device. The electronically controlled hydraulic brake device controls an actuator according to the information input from the travel control unit 160 and transfers the hydraulic pressure of the master cylinder to the cylinder. Further, the brake device 220 may include a regenerative brake using the travel motor that may be included in the travel driving force output device 200.

[Vehicle Control System]

Hereinafter, the vehicle control system 100 will be described. The vehicle control system 100 is realized by, for example, one or more processors or hardware having equivalent functions. The vehicle control system 100 may have a configuration in which a processor such as a central processing unit (CPU), a storage device, an electronic control unit (ECU) in which a communication interface is connected by an internal bus, a micro-processing unit (MPU), and the like are combined.

Referring back to FIG. 2, the vehicle control system 100 includes, for example, a target lane determination unit 110, an automatic driving control unit 120, a travel control unit 160, and a storage unit 180. The automatic driving control unit 120 includes, for example, an automatic driving mode control unit 130, a vehicle position recognition unit 140, an external environment recognition unit 142, an action plan generation unit 144, a trajectory generation unit 146, and a switching control unit 150. Each unit of the target lane determination unit 110 and the automatic driving control unit 120 and a portion or all of the travel control unit 160 are realized by the processor executing a program (software). Further, some or all of these may be realized by hardware such as a large scale integration (LSI) circuit or an application specific integrated circuit (ASIC) or may be realized by a combination of software and hardware.

For example, information such as high-precision map information 182, target lane information 184, and action planning information 186 is stored in the storage unit 180. The storage unit 180 is realized by a read only memory (ROM), a random access memory (RAM), a hard disk drive (HDD), a flash memory, or the like. The program executed by the processor may be stored in the storage unit 180 in advance, or may be downloaded from an external device via vehicle Internet equipment or the like. Further, the program may be installed in the storage unit 180 by a portable storage medium having the program stored thereon being mounted on a drive device (not illustrated). Further, the vehicle control system 100 may be one distributed by a plurality of computer devices.

The target lane determination unit 110 is realized by, for example, an MPU. The target lane determination unit 110 divides a route provided from the navigation device 50 into a plurality of blocks (for example, divides the route every 100 [m] with respect to a vehicle traveling direction), and determines a target lane for each block with reference to the high-precision map information 182. The target lane determination unit 110 determines, for example, what lane from the left the vehicle travels along. For example, when there is a branching point, a merging point, or the like in the route, the target lane determination unit 110 determines the target lane so that the host vehicle M can travel along a reasonable travel route for traveling to a branch destination. The target lane determined by the target lane determination unit 110 is stored as target lane information 184 in the storage unit 180.

The high-precision map information 182 is map information that has higher precision than a navigation map of the navigation device 50. The high-precision map information 182 includes, for example, information on a center of the lane or information on a boundary of the lane. Further, road information, traffic regulation information, address information (address and postal code), facility infoi nation, telephone number information, or the like may be included in the high-precision map information 182. The road information includes information indicating a type of road, such as highways, toll roads, national roads, and prefectural roads, the number of lanes of a road, a width of each lane, a road grade, a position of the road (three-dimensional coordinates including longitude, latitude, and height), curvatures of curves of lanes, positions of merging and branching points of a lane, or information on signs or the like provided on a road. The traffic control information includes information on blockage of lanes due to construction, traffic accidents, traffic jams, or the like.

The automatic driving mode control unit 130 determines a mode of the automatic driving that is performed by the automatic driving control unit 120. The automatic driving modes in this embodiment include the following modes. The following are merely examples, and the number of modes of automatic driving may be set arbitrarily.

[Mode A]

Mode A is a mode in which a degree of automatic driving is highest. When mode A is performed, all vehicle controls such as complex merging control are automatically performed. Therefore, the vehicle occupant does not need to monitor the vicinity or the state of the host vehicle M.

[Mode B]

Mode B is a mode in which a degree of automatic driving is next highest after mode A. When mode B is performed, all vehicle controls are automatically performed in principle, but a driving operation of the host vehicle M is entrusted to the vehicle occupant according to a situation. Therefore, the vehicle occupant needs to monitor the vicinity or the state of the host vehicle M.

[Mode C]

Mode C is a mode in which the degree of automatic driving is next highest after mode B. When mode C is performed, the vehicle occupant needs to perform a confirmation operation according to a situation with respect to the HMI 70. In mode C, for example, when the vehicle occupant is notified of a lane changing timing and performs an operation for instructing lane changing with respect to the HMI 70, automatic lane change is performed. Therefore, the vehicle occupant needs to monitor the vicinity or the state of the host vehicle M.

The automatic driving mode control unit 130 determines an automatic driving mode on the basis of an operation of the vehicle occupant with respect to the HMI 70, the event determined by the action plan generation unit 144, the travel condition determined by the trajectory generation unit 146, and the like. The HMI control unit 170 is notified of the automatic driving mode. Further, in the automatic driving mode, a limit according to performance of the detection device DD of the host vehicle M, or the like may be set. For example, when the performance of the detection device DD is low, mode A may not be performed. In any of the modes, switching to a manual driving mode (override) can be performed by an operation with respect to the configuration of the driving operation system in the HMI 70.

The vehicle position recognition unit 140 of the automatic driving control unit 120 recognizes a lane in which the host vehicle M is traveling (a travel lane), and a relative position of the host vehicle M with respect to the travel lane on the basis of the high-precision map infoi nation 182 stored in the storage unit 180 and the information input from the finders 20, the radars 30, the camera 40, the navigation device 50, or the vehicle sensors 60.

The vehicle position recognition unit 140, for example, compares a pattern of a lane marking recognized from the high-precision map information 182 (for example, an arrangement of solid and dotted lines) with a pattern of the lane marking around the host vehicle M recognized from an image captured by the camera 40 to recognize the travel lane. In this recognition, a position of the host vehicle M that is acquired from the navigation device 50 or a processing result of the INS may be taken into account.

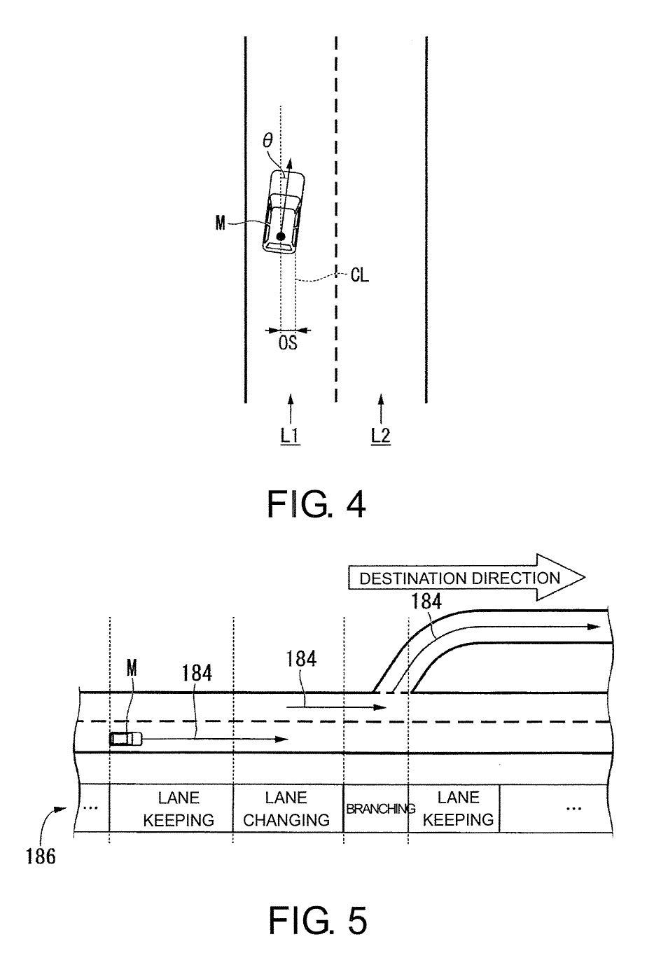

FIG. 4 is a diagram illustrating a state in which a relative position of the host vehicle M with respect to a travel lane L1 is recognized by the vehicle position recognition unit 140. The vehicle position recognition unit 140 recognizes, for example, a divergence OS from a travel lane center CL of a reference point (for example, the centroid) of the host vehicle M and an angle θ formed between a traveling direction of the host vehicle M and a line connected to the travel lane center CL, as the relative position of the host vehicle M with respect to the travel lane L1. Instead of this, the vehicle position recognition unit 140 may recognize, for example, a position of a reference point of the host vehicle M with respect to any one of side ends of the host vehicle lane L1 as the relative position of the host vehicle M with respect to the travel lane. The relative position of the host vehicle M recognized by the vehicle position recognition unit 140 is provided to the action plan generation unit 144.

The external environment recognition unit 142 recognizes a state such as a position, a speed, or an acceleration of surrounding vehicles on the basis of the information input from the finder 20, the radar 30, the camera 40, or the like. A surrounding vehicle is, for example, a vehicle that travels near the host vehicle M, which is a vehicle that travels in the same direction as the host vehicle M. A position of the surrounding vehicle may be represented by a representative point such as the centroid or a corner of another vehicle or may be represented by a region represented by an outline of the other vehicle. The “state” of the surrounding vehicle may include an acceleration of the surrounding vehicle, and whether or not the surrounding vehicle is changing lanes (or whether the surrounding vehicle is trying to change lanes), which is recognized on the basis of the information of the various devices. Further, the external environment recognition unit 142 recognizes positions of guard rails, utility poles, parked vehicles, pedestrians, or other objects, in addition to the surrounding vehicles.

The action plan generation unit 144 sets a start point of automatic driving and/or a destination of automatic driving. The start point of automatic driving may be a current position of the host vehicle M or a point at which an operation for instructing the automatic driving is performed. The action plan generation unit 144 generates an action plan in a section between the start point and the destination of automatic driving. However, the present invention is not limited thereto, and the action plan generation unit 144 may generate an action plan for an arbitrary section.

The action plan includes, for example, a plurality of events that are executed sequentially. The events include, for example, a deceleration event in which the host vehicle M is caused to decelerate, an acceleration event in which the host vehicle M is caused to accelerate, a lane keeping event in which the host vehicle M is caused to travel so that the host vehicle M does not deviate from a travel lane, a lane changing event in which the travel lane is caused to be changed, a overtaking event in which the host vehicle M is caused to overtake a preceding vehicle, a branching event in which a change to a desired lane occurs at a branching point or the host vehicle M is caused to travel so as not to deviate from a current travel lane, a merging event in which the host vehicle M is caused to be accelerated or decelerated in a merging lane for merging a main lane and the travel lane is caused to be changed, and a handover event in which the driving mode is caused to transition from an automatic driving mode to a manual driving mode at a scheduled end point of the automatic driving mode. The action plan generation unit 144 sets a lane changing event, a branching event, or a merging event to a point at which the target lane determined by the target lane determination unit 110 is switched. Information indicating the action plan generated by the action plan generation unit 144 is stored as the action plan information 186 in the storage unit 180.

FIG. 5 is a diagram illustrating an example of an action plan generated for a certain section. As illustrated in FIG. 5, the action plan generation unit 144 generates an action plan required for the host vehicle M to travel along a target lane indicated by the target lane information 184. The action plan generation unit 144 may dynamically change the action plan regardless of the target lane information 184 according to changes in a situation of the host vehicle M. For example, the action plan generation unit 144 may change an event set in a driving section in which the host vehicle M is scheduled to travel when a speed of a surrounding vehicle recognized by the external environment recognition unit 142 during the vehicle travel exceeds a threshold value or a moving direction of a surrounding vehicle traveling in a lane adjacent to the host vehicle lane is directed to a moving direction of the host vehicle lane. For example, when an event is set so that a lane changing event is executed after a lane keeping event, and it is found from a recognition result of the external environment recognition unit 142 that a vehicle is traveling at a speed equal to or higher than a threshold value from the rear in a lane that is a lane change destination in the lane keeping event, the action plan generation unit 144 may change the event subsequent to the lane keeping event from a lane changing event to a deceleration event or a lane keeping event. As a result, the vehicle control system 100 can cause the host vehicle M to automatically travel safely even when a change in a state of the external environment occurs.

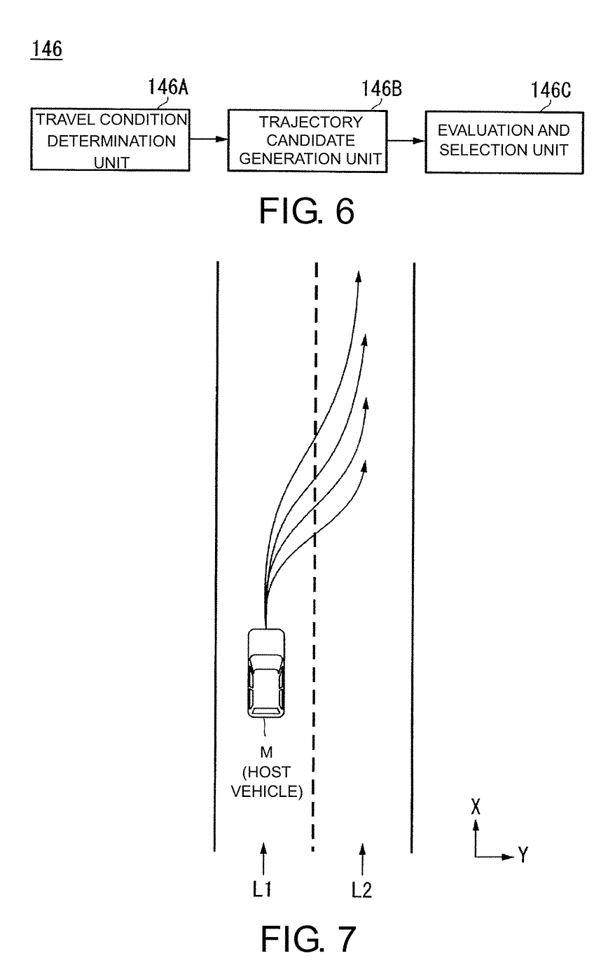

FIG. 6 is a diagram illustrating an example of a configuration of the trajectory generation unit 146. The trajectory generation unit 146 includes, for example, a travel condition determination unit 146A, a trajectory candidate generation unit 146B, and an evaluation and selection unit 146C.

For example, when a lane keeping event is performed, the travel condition determination unit 146A determines a travel condition of any one of constant speed travel, follow-up travel, low-speed follow-up travel, deceleration travel, cornering, obstacle avoidance travel, and the like. For example, the travel condition determination unit 146A may determine the travel condition to be constant speed travel when there are no other vehicles ahead of the host vehicle M. Further, the travel condition determination unit 146A determines the travel condition as follow-up travel when traveling by following a preceding vehicle. Further, the travel condition determination unit 146A determines the travel condition to be low-speed follow-up travel in a traffic jam situation or the like. Further, the travel condition determination unit 146A determines the travel condition to be deceleration travel when deceleration of a preceding vehicle is recognized by the external environment recognition unit 142 or when an event such as stopping or parking of a vehicle is performed. Further, when the external environment recognition unit 142 recognizes that the host vehicle M has reached a curved road, the travel condition determination unit 146A determines the travel condition to be cornering. Further, the travel condition determination unit 146A determines the travel condition to be obstacle avoidance travel when the external environment recognition unit 142 recognizes an obstacle in front of the host vehicle M. Further, when a lane change event, a overtaking event, a branching event, a merging event, a handover event, or the like is performed, the travel condition determination unit 146A determines the travel condition according to each event.

The trajectory candidate generation unit 146B generates candidates for a trajectory on the basis of the travel condition determined by the travel condition determination unit 146A. FIG. 7 is a diagram illustrating an example of candidates for a trajectory generated by the trajectory candidate generation unit 146B. FIG. 7 illustrates the candidates for the trajectory generated when the host vehicle M changes a lane from a lane L1 to a lane L2.

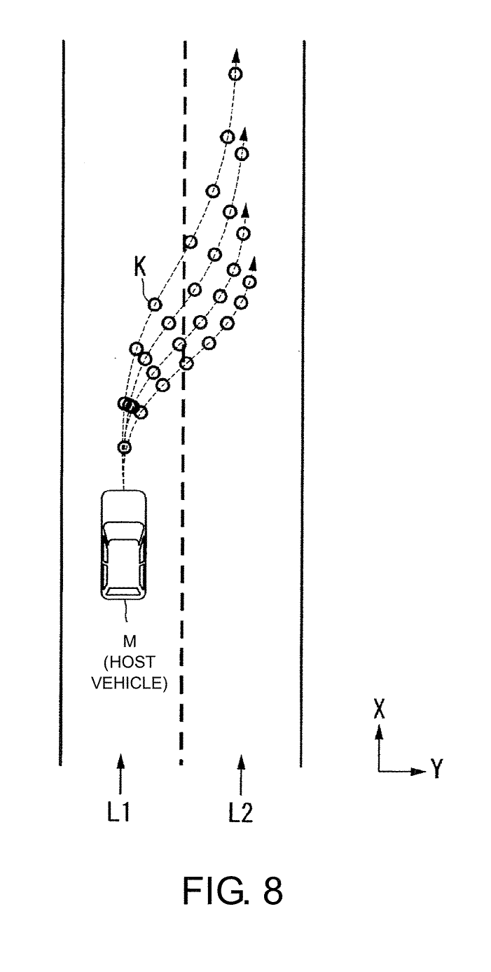

The trajectory candidate generation unit 146B determines a trajectory as illustrated in FIG. 7, for example, as a collection of target positions (trajectory points K) that a reference position (for example, the centroid or a rear wheel shaft center) of the host vehicle M will reach, at future predetermined time intervals. FIG. 8 is a diagram in which candidates for the trajectories generated by the trajectory candidate generation unit 146B are represented by the trajectory points K. As an interval between the trajectory points K becomes wider, the speed of the host vehicle M increases, and as the interval between the trajectory points K becomes narrower, the speed of the host vehicle M decreases. Therefore, the trajectory candidate generation unit 146B gradually increases the interval between the trajectory points K when acceleration is desired, and gradually decreases the interval between the trajectory points K when deceleration is desired.

Thus, since the trajectory point K includes a speed component, the trajectory candidate generation unit 146B needs to apply a target speed to each trajectory point K. The target speed is determined according to the travel condition determined by the travel condition determination unit 146A.

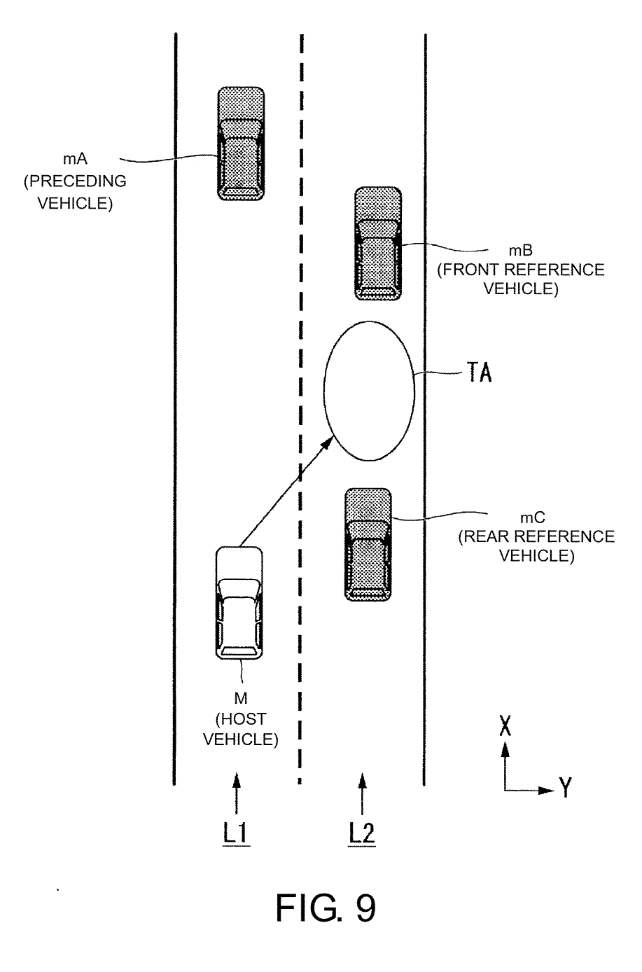

Here, a scheme of determining the target speed when lane change (including branching) is performed will be described. The trajectory candidate generation unit 146B first sets a lane change target position (or a merging target position). The lane change target position is set as a relative position with respect to a surrounding vehicle, and is intended to determine “surrounding vehicles between which the lane change is performed”. The trajectory candidate generation unit 146B determines the target speed when the lane change is performed in consideration of three surrounding vehicles with reference to the lane change target position. FIG. 9 is a diagram illustrating the lane change target position TA. In FIG. 9, L1 indicates the own lane, and L2 indicates an adjacent lane. Here, a surrounding vehicle traveling immediately before the host vehicle M in the same lane as the host vehicle M is defined as a preceding vehicle mA, a surrounding vehicle traveling immediately before the lane change target position TA is defined as a front reference vehicle mB, and a surrounding vehicle traveling immediately after the lane change target position TA is defined as a rear reference vehicle mC. The host vehicle M needs to perform acceleration and deceleration to move to the side of the lane change target position TA, but in this case, the host vehicle M needs to avoid catching up with the preceding vehicle mA. Therefore, the trajectory candidate generation unit 146B predicts future states of the three surrounding vehicles, and determines a target speed such that there is no interference with each surrounding vehicle.

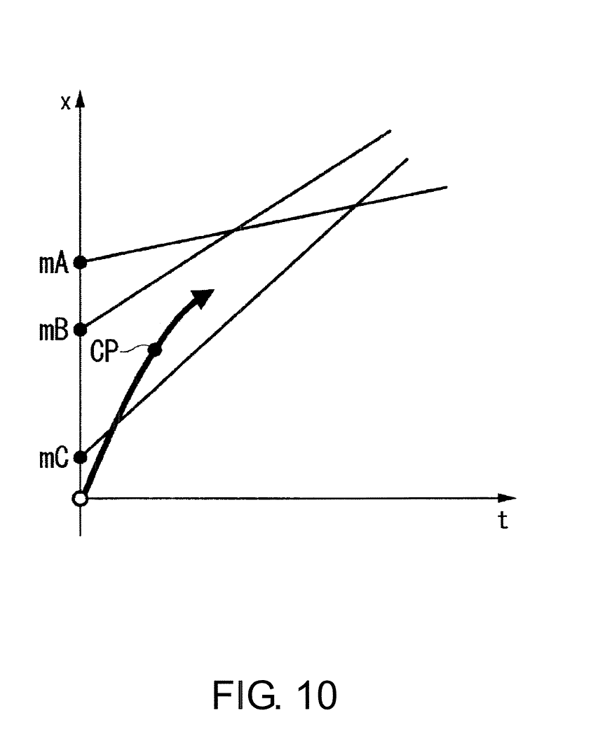

FIG. 10 is a diagram illustrating a speed generation model when speeds of three surrounding vehicles are assumed to be constant. In FIG. 10, straight lines extending from mA, mB, and mC indicate displacements in the traveling direction when the respective surrounding vehicles are assumed to travel at constant speed. The host vehicle M needs to be between the front reference vehicle mB and the rear reference vehicle mC at a point CP at which the lane change is completed, and behind the preceding vehicle mA at a point before the point CP. Under such constraints, the trajectory candidate generation unit 146B derives a plurality of time series patterns of a target speed before the lane change is completed. By applying the time series patterns of the target speed to a model such as a spline curve, a plurality of candidates for the trajectory as illustrated in FIG. 8 are derived. A motion pattern for the three surrounding vehicles is not limited to constant speeds as illustrated in FIG. 10, and may be predicted on the assumption of constant accelerations or constant jerks.

The evaluation and selection unit 146C, for example, evaluates candidates for the trajectory generated by the trajectory candidate generation unit 146B from two viewpoints of planability and safety, and selects the trajectory to be output to the travel control unit 160. From the point of view of planability, for example, when follow-up with respect to an already generated plan (for example, action plan) is high and a total length of the trajectory is short, the evaluation of the trajectory is high. For example, when a lane change to the right is desired, the evaluation of a trajectory returning after a temporary lane change to the left is low. From the viewpoint of the safety, for example, as a distance between the host vehicle and an object (for example, a surrounding vehicle) is long at each trajectory point and the amount of a change in the acceleration/deceleration or the steering angle is small, the evaluation is high.

The switching control unit 150 switches between the automatic driving mode and the manual driving mode on the basis of the signal input from the automatic driving changeover switch 87. Further, the switching control unit 150 switches from the automatic driving mode to the manual driving mode on the basis of an operation of instructing acceleration/deceleration or steering with respect to the configuration of the driving operation system in the HMI 70. For example, the switching control unit 150 switches from the automatic driving mode to the manual driving mode (overriding) in a state in which an operation amount indicated by the signal input from the configuration of the driving operation system in the HMI 70 exceeds a threshold value. Further, the switching control unit 150 may cause a return to the automatic driving mode to occur when the operation with respect to a configuration of the driving operation system in the HMI 70 is not detected for a predetermined time after switching to the manual driving mode is performed by overriding.

The travel control unit 160 controls the travel driving force output device 200, the steering device 210, and the brake device 220 so that the host vehicle M passes through the trajectory generated by the trajectory generation unit 146 at a scheduled time.

The HMI control unit 170 controls notification or the like at the time of driving switching.

[Example of notification to vehicle occupant in transition from automatic driving to manual driving]

Hereinafter, an example of a notification to the vehicle occupant in a transition from automatic driving to manual driving in the vehicle control system 100 and the HMI 70 according to the first embodiment will be described with reference to the drawings.

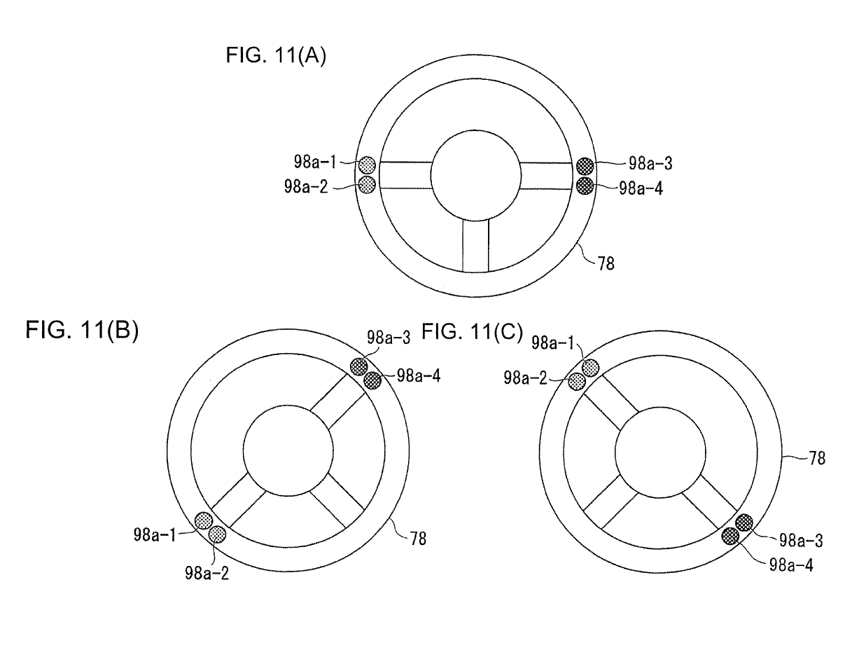

FIG. 11 is a diagram illustrating an example of notification of a driving operation for steering to the vehicle occupant in the requested operation information notification unit 98a.

FIG. 11(A) illustrates a state in which the steering wheel 78 is not rotated to either the left or the right (a steering angle is 0°), that is, a state in which the vehicle steered by the steering wheel 78 is traveling straight when a transition from automatic driving to manual driving occurs due to a handover event.

As illustrated in FIG. 11(A), requested operation information notification units 98a are installed in the steering wheel 78, two at the right and two at the left. Specifically, the requested operation information notification unit 98a-1 and the requested operation information notification unit 98a-2 are arranged side by side at upper and lower positions in the left side of the steering wheel 78, and the requested operation information notification unit 98a-3 and the requested operation information notification unit 98a-4 are arranged side by side at upper and lower positions in the right side of the steering wheel 78.

FIG. 11(B) illustrates a state in which the steering wheel 78 is rotated by about 45° in a left direction (a steering angle is about 45° in the left direction), that is, a state in which the vehicle steered by the steering wheel 78 is traveling while turning in the left direction when a transition from automatic driving to manual driving occurs due to a handover event. FIG. 11(C) illustrates a state in which the steering wheel 78 is rotated by about 45° in a right direction (the steering angle is about 45° in the right direction), that is, a state in which the vehicle steered by the steering wheel 78 is traveling while turning in the right direction when the transition from automatic driving to manual driving occurs due to a handover event.

The requested operation infoiivation notification unit 98a according to the first embodiment includes, for example, a light emitting diode (LED). The requested operation information notification unit 98a includes a light emitting diode that can emit light of three primary colors (RGB), and can represent various colors by mixing light emission of respective colors at different proportions.

When the transition from automatic driving to manual driving occurs due to a handover event, the requested operation info nation notification unit 98a emits light, making it possible for the vehicle occupant to recognize the steering angle of the steering wheel 78 even in a situation in which the inside of the vehicle is dark and it is difficult for the steering wheel to be viewed, for example, at night or the like. Accordingly, the vehicle occupant can determine a position at which the steering wheel 78 is gripped when the transition from automatic driving to manual driving occurs.

For example, the colors of lights emitted by the requested operation information notification units 98a at the left and the right are caused to be different as illustrated in FIG. 11, making it possible for the vehicle occupant to correctly recognize left and right positions of the steering wheel even in a situation in which the inside of the vehicle is dark and it is difficult for the steering wheel to be viewed. For example, the requested operation information notification unit 98a-1 and the requested operation information notification unit 98 A-2 emit red light, and the requested operation information notification unit 98a-3 and the requested operation information notification unit 98a-4 emit blue light, making it possible for the vehicle occupant to correctly recognize the left and right positions of the steering wheel.

Further, as another example, for example, the respective requested operation information notification units 98a in the upper side (that is, the requested operation information notification unit 98a-1 and the requested operation information notification unit 98a-3) among the requested operation information notification units 98a installed at the right and left, two at the right and two at the left, are caused to emit red light, and the respective requested operation information notification units 98a in the lower side (that is, the requested operation information notification unit 98a-2 and the requested operation information notification unit 98a-4) among the requested operation information notification units 98a installed at the right and left, two at the right and two at the left, are caused to emit blue light, making it possible for the vehicle occupant to correctly recognize a vertical direction of the steering wheel even in a situation in which the inside of the vehicle is dark and it is difficult for the steering wheel to be viewed. Accordingly, the vehicle occupant can correctly recognize left and right positions of the steering wheel on the basis of the recognition of the vertical direction and a light emission position.

Further, as another example, for example, the requested operation information notification units 98a at the left (that is, the requested operation information notification unit 98a-1 and the requested operation info nation notification unit 98a-2) among the requested operation information notification units 98a installed at the right and left, two at the right and two at the left, are caused to blink and emit light, and the requested operation information notification units 98a at the right (that is, the requested operation information notification unit 98a-3 and the requested operation information notification unit 98a-4) are caused to emit light without blinking, making it possible for the vehicle occupant to correctly recognize left and right positions of the steering wheel even in a situation in which the inside of the vehicle is dark and it is difficult for the steering wheel to be viewed.

Such a requested operation information notification unit 98a may be provided in a circumferential direction in a section of a rim of the steering wheel 78, but the requested operation information notification unit 98a may be provided in a viewable range (for example, the front side when viewed from the vehicle occupant) when the vehicle occupant sits in a driver seat, thereby improving visibility.

[Operation of vehicle control system 100 and HMI 70]

Hereinafter, an operation of the vehicle control system 100 and the HMI 70 in the notification to the vehicle occupant in the transition from automatic driving to manual driving will be described with reference to the drawings.

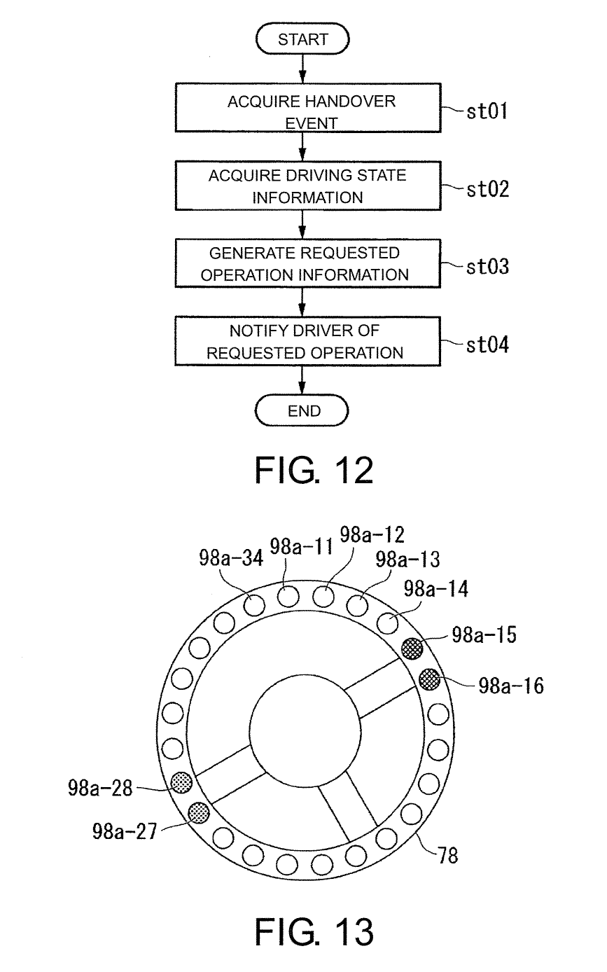

FIG. 12 is a flowchart illustrating an operation of a notification of the driving operation for steering to the vehicle occupant in the HMI 70. This flowchart starts when performance of the handover event is started by the automatic driving control unit 120.

(Step st01) The driving state information acquisition unit 96 acquires, through the HMI control unit 170, information indicating the handover event performed by the automatic driving control unit 120. Then, the process proceeds to step st02.

(Step st02) The driving state information acquisition unit 96 acquires driving state information indicating a state of automatic driving regarding steering of the vehicle on the basis of performance of a handover event which is an event indicating a transition from automatic driving to manual driving in driving control of the vehicle. The driving state information acquisition unit 96 outputs the acquired driving state information to the requested operation information generation unit 97. Then, the process proceeds to step st03.

(Step st03) The requested operation information generation unit 97 generates requested operation information indicating a notification for causing the transition from automatic driving to manual driving to be smooth on the basis of the driving state information input from the driving state information acquisition unit 96. The requested operation information generation unit 97 outputs the generated requested operation information to the requested operation information notification unit 98a. Then, the process proceeds to step st04.

(Step st04) The requested operation information notification unit 98a performs a notification for causing the transition from automatic driving to manual driving to be smoothly performed to the vehicle occupant on the basis of the requested operation information generated by the requested operation information generation unit 97. Then, the process of this flowchart ends.

[Another Example of Notification to Vehicle Occupant in Transition from Automatic Driving to Manual Driving]

Hereinafter, another example of the notification to the vehicle occupant in the transition from automatic driving to manual driving in the vehicle control system 100 and the HMI 70 according to the first embodiment will be described with reference to the drawings.

FIG. 13 is a diagram illustrating another example of notification of a driving operation for steering to the vehicle occupant in the requested operation information notification unit 98a.

As illustrated, requested operation information notification units 98a are installed side by side along an outer periphery of the steering wheel 78 in the steering wheel 78. More specifically, 24 requested operation information notification units 98a including a requested operation information notification unit 98a-11, a requested operation information notification unit 98a-12, . . . , and a requested operation information notification unit 98a-34 are installed along the outer periphery of the steering wheel 78.

In this notification example, the HMI 70 can arbitrarily cause the 24 requested operation information notification units 98a to emit light on the basis of the driving state information.

For example, the HMI 70 causes the requested operation information notification units 98a corresponding to positions at which the vehicle occupant should grip the steering wheel 78 with his or her left and right hands, to emit light on the basis of the steering angle signal included in the driving state information. In the example illustrated in FIG. 13, the HMI 70 causes the requested operation information notification unit 98a-27 and the requested operation information notification unit 98a-28 corresponding to a position at which the vehicle occupant should grip the steering wheel with the left hand, to emit red light, and causes the requested operation information notification unit 98a-15 and the requested operation infonnation notification unit 98a-16 corresponding to a position at which the vehicle occupant should grip the steering wheel with the right hand, to emit blue light.

Accordingly, the vehicle occupant can intuitively recognize positions of the steering wheel 78 to be gripped even in a situation in which the inside of the vehicle is dark and it is difficult for the steering wheel to be viewed, for example, at night or the like.

Further, for example, the HMI 70 may cause the requested operation information notification unit 98a to emit light to indicate a direction and an intensity of the steering torque on the basis of the steering torque signal included in the driving state information.

For example, when the steering torque in a right direction is generated, the HMI 70 sequentially causes the requested operation information notification unit 98a-11, the requested operation information notification unit 98a-12, the requested operation information notification unit 98a-13, . . . to emit light in this order. Accordingly, the vehicle occupant can recognize the direction of the steering torque because a light emission portion is viewed as if the light emission portion is rotated clockwise along an outer periphery of the steering wheel 78. For example, when the steering torque in a left direction is generated, the HMI 70 sequentially causes the requested operation information notification unit 98a-13, the requested operation infoiination notification unit 98a-12, the requested operation information notification unit 98a-11, . . . to emit light in this order, contrary to the above.

Further, for example, the HMI 70 changes a timing at which light emission is switched when sequentially causing the requested operation information notification units 98a to emit light according to the intensity of the steering torque. For example, the HMI 70 makes the light emission switching earlier when sequentially causing the requested operation information notification units 98a to emit light when the steering torque is stronger, and makes the light emission switching later when sequentially causing the requested operation information notification units 98a to emit light when the steering torque is weaker. Accordingly, the vehicle occupant can view the light emission portion as if the light emission portion is rotated along the outer periphery of the steering wheel 78, and can recognize the intensity of the steering torque according a speed of the rotation.

Accordingly, the vehicle occupant can intuitively recognize the intensity of the steering torque of the steering wheel 78, and can smoothly perform takeover of driving behavior associated with the transition from automatic driving to manual driving.

As described above, according to the vehicle control system 100 and the HMI 70 according to the first embodiment, it is possible to prompt smooth takeover of driving behavior of the driver. According to the vehicle control system 100 and the HMI 70 according to the first embodiment, a specific state of the steering angle or the operation force of the steering wheel can be recognized.

Further, according to the vehicle control system 100 and the HMI 70 according to the first embodiment, the position at which the steering wheel is gripped can be intuitively recognized. According to the vehicle control system 100 and the HMI 70 according to the first embodiment, a state in which a specific force is applied to the steering wheel can be recognized.

### Second Embodiment

Hereinafter, a second embodiment will be described. The vehicle control system 100 and the HMI 70 according to the first embodiment notify the vehicle occupant of the requested operation information on steering of the vehicle using the requested operation information notification unit 98a. A vehicle control system 100 and an HMI 70 according to the second embodiment to be described below notify a vehicle occupant of requested operation information on acceleration and deceleration of a vehicle using a requested operation information notification unit 98b and a requested operation information notification unit 98c.

Description of the same configurations as in the vehicle control system 100 and the HMI 70 according to the first embodiment will be omitted and only portions having different configurations will be described.

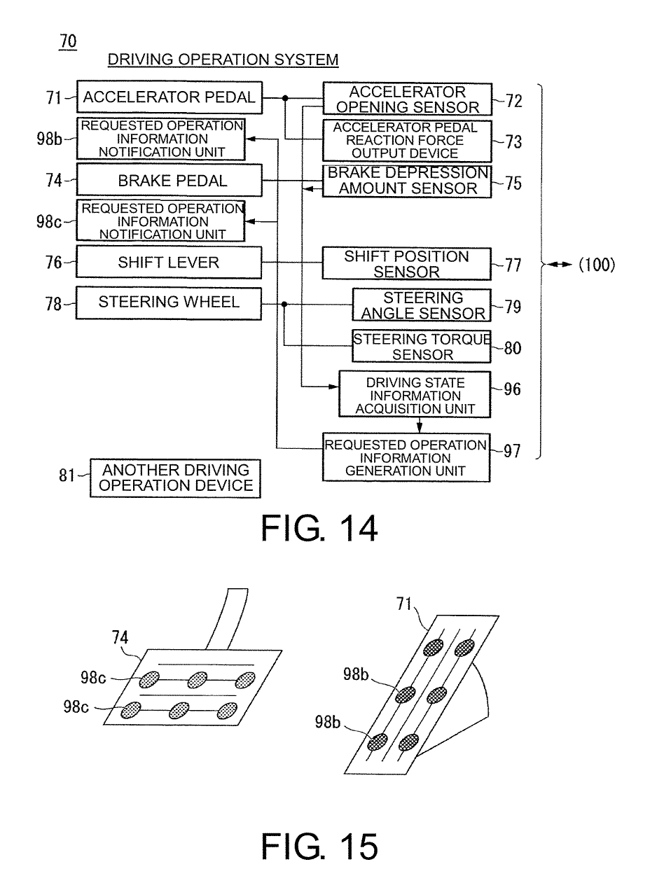

FIG. 14 is a configuration diagram of a function of the driving operation system of the HMI 70.

The HMI 70 includes, for example, an accelerator pedal 71, an accelerator opening sensor 72, an accelerator pedal reaction force output device 73, a brake pedal 74, a brake depression amount sensor (or, for example, a master pressure sensor) 75, a shift lever 76, a shift position sensor 77, a steering wheel 78, a steering angle sensor 79, a steering torque sensor 80, another driving operation device 81, a driving state information acquisition unit 96, a requested operation information generation unit 97, a requested operation information notification unit 98b, and a requested operation information notification unit 98c, as the configuration of the driving operation system.

The requested operation information notification unit 98b is included in the accelerator pedal 71, and the requested operation information notification unit 98c is included in the brake pedal 74.

The driving state information acquisition unit 96 acquires driving state information indicating a state of automatic driving regarding acceleration or deceleration of the vehicle on the basis of performance of a handover event which is an event indicating a transition from automatic driving to manual driving in driving control of the vehicle.

Specifically, for example, if the handover event included in the action plan information 186 created by the action plan generation unit 144 and stored in the storage unit 180 is performed by the automatic driving control unit 120, information indicating the handover event is output to the driving state information acquisition unit 96 of the HMI 70 via the HMI control unit 170. If the information indicating the handover event is input, the driving state information acquisition unit 96 acquires the driving state information indicating a state of automatic driving regarding acceleration or deceleration of the vehicle. The driving state information is, for example, information including the accelerator opening signal indicating the depression amount or the depression force (operation force) of the accelerator pedal acquired from the accelerator opening sensor 72, and the brake signal indicating the depression amount or the depression force (operation force) of the brake pedal acquired from the brake depression amount sensor 75. According to the by-wire technology or the like, the state of the operation device (for example, a state of the depression amount of the accelerator pedal or the brake pedal) and a control state regarding acceleration and deceleration in automatic driving may not match.

The driving state information acquisition unit 96 outputs the acquired driving state information to the requested operation information generation unit 97.

The handover event may be performed on the basis of the operation of the automatic driving changeover switch 87 to be described below.

The requested operation information generation unit 97 generates requested operation information indicating a notification for causing the transition from automatic driving to manual driving to be smooth on the basis of the driving state information acquired by the driving state information acquisition unit.

Specifically, the requested operation information generation unit 97 generates, for example, requested operation information indicating notification for causing the transition from automatic driving to manual driving to be smooth on the basis of the accelerator opening signal or the brake signal included in the input driving state information. The requested operation information includes, for example, one or a plurality of pieces of information among information indicating the requested operation information notification unit 98b and the requested operation information notification unit 98c that emit light among a plurality of requested operation information notification units 98b and requested operation information notification units 98c to be described below, information indicating the color of the light emitted by the requested operation information notification unit 98b and the requested operation information notification unit 98c, information indicating whether the light emitted by the requested operation information notification unit 98b and the requested operation information notification unit 98c is caused to blink, information indicating a blinking interval of the light emitted by the requested operation information notification unit 98b and the requested operation information notification unit 98c, and information indicating an order or a timing of light emission of the plurality of the requested operation info nation notification unit 98b and the requested operation info nation notification unit 98c.

The requested operation information generation unit 97 outputs the generated requested operation information to the requested operation information notification unit 98b and the requested operation information notification unit 98c.

The requested operation information notification unit 98b and the requested operation information notification unit 98c perform a notification for causing the transition from automatic driving to manual driving to be smoothly performed to the vehicle occupant on the basis of the requested operation information generated by the requested operation information generation unit 97.

Specifically, the requested operation information notification unit 98b is included in the accelerator pedal 71. For example, the requested operation information notification unit 98b performs at least one of light emission and display for notifying the vehicle occupant that the foot should be put on the accelerator pedal 71 on the basis of the requested operation information input from the requested operation information generation unit 97. Further, specifically, the requested operation information notification unit 98c is included the brake pedal 74. For example, the requested operation information notification unit 98c performs at least one of light emission and display for notifying the vehicle occupant that foot should be put on the brake pedal 74 on the basis of the requested operation information input from the requested operation information generation unit 97.

The requested operation information notification unit 98b may perform at least one of light emission and display for notifying the vehicle occupant of the depression amount or the depression force (operation force) of the accelerator pedal 71 on the basis of the accelerator opening signal. Further, the requested operation information notification unit 98c may perform at least one of light emission and display for notifying the vehicle occupant of the depression amount or the depression force (operation force) of the brake pedal 74 on the basis of the brake signal.

[Example of Notification to Vehicle Occupant in Transition from Automatic Driving to Manual Driving]

Hereinafter, an example of the notification to the vehicle occupant in the transition from automatic driving to manual driving in the vehicle control system 100 and the HMI 70 according to the second embodiment will be described with reference to the drawings.

FIG. 15 is a diagram illustrating an example of notification of a driving operation for acceleration or deceleration to the vehicle occupant in the requested operation information notification unit 98b and the requested operation information notification unit 98c.

As illustrated, six requested operation information notification units 98b are installed on a front surface of the accelerator pedal 71 (that is, a portion that is depressed by the vehicle occupant). In this notification example, the HMI 70 can arbitrarily cause the six requested operation information notification units 98b to emit light on the basis of the driving state information.

Further, as illustrated, six requested operation information notification units 98c are installed on a front surface of the brake pedal 74 (that is, a portion that is depressed by the vehicle occupant). In this notification example, the HMI 70 can arbitrarily cause the six requested operation information notification units 98c to emit light on the basis of the driving state information.

For example, the HMI 70 causes the requested operation information notification unit 98b installed in the accelerator pedal 71 to emit light on the basis of the accelerator opening signal included in the driving state information. Accordingly, the vehicle occupant can intuitively recognize that his or her foot should be put on the accelerator pedal 71.

Further, for example, the HMI 70 causes the requested operation information notification unit 98c installed in the brake pedal 74 to emit light on the basis of the brake signal included in the driving state information. Accordingly, the vehicle occupant can intuitively recognize that his or her foot should be put on the brake pedal 74.

A color of the light emitted by the requested operation information notification unit 98b installed in the accelerator pedal 71 and a color of the light emitted by the requested operation information notification unit 98c installed in the brake pedal 74 are different, making it possible for the vehicle occupant to intuitively determine whether the foot should be put on the accelerator pedal 71 or the foot should be put on the brake pedal 74.

Further, for example, the HMI 70 may cause the requested operation information notification unit 98b to emit light to indicate a depression amount or a depression force (operation force) of the accelerator pedal 71 on the basis of the accelerator opening signal included in the driving state information. Further, for example, the HMI 70 may cause the requested operation information notification unit 98c to emit light to indicate a depression amount or a depression force (operation force) of the brake pedal 74 on the basis of the brake signal included in the driving state information.

For example, the HMI 70 causes the light emitted from the requested operation information notification unit 98b or the requested operation information notification unit 98c to blink more quickly when the depression amount or the depression force (operation force) of the accelerator pedal 71 or the depression amount or the depression force (operation force) of the brake pedal 74 is larger. Accordingly, the vehicle occupant can intuitively recognize the depression amount or the depression force (operation force) of the accelerator pedal 71 or the depression amount or the depression force (operation force) of the brake pedal 74 on the basis of a blinking speed of the light emitted from the requested operation information notification unit 98b or the requested operation information notification unit 98c, and can smoothly perform takeover of driving behavior associated with the transition from automatic driving to manual driving.

As described above, according to the vehicle control system 100 and the HMI 70 according to the second embodiment, it is possible to prompt smooth takeover of driving behavior of the driver. Further, according to the vehicle control system 100 and the HMI 70 according to the second embodiment, a state of a specific depression amount or depression force (operation force) of the accelerator pedal or the brake pedal can be recognized.

Further, according to the vehicle control system 100 and the HMI 70 according to the second embodiment, whether the foot should be put on the accelerator pedal or whether the foot should be put on the brake pedal can be intuitively recognized. Further, according to the vehicle control system 100 and the HMI 70 according to the second embodiment, a specific depression amount or depression force (operation force) to depress the accelerator pedal or the brake pedal can be recognized.

### Third Embodiment

Hereinafter, a third embodiment will be described. The vehicle control system 100 and the HMI 70 according to the second embodiment have notified the vehicle occupant of the requested operation information on the acceleration and deceleration of the vehicle using the requested operation information notification unit 98b and the requested operation information notification unit 98c. However, it is conceivable that it may be difficult for the information to be recognized by the vehicle occupant according to brightness of the vicinity of the host vehicle M, for example, in a period of bright daylight or the like through light emission of the requested operation information notification unit 98b and the requested operation information notification unit 98c installed in the accelerator pedal and the brake pedal or installed near the accelerator pedal and the brake pedal.

A vehicle control system 100 and an HMI 70 according to the third embodiment to be described below notify a vehicle occupant of requested operation information on acceleration and deceleration of a vehicle using the display device 82 of the HMI 70 illustrated in FIG. 3.

Description of the same configurations as in the vehicle control system 100 and the HMI 70 according to the first embodiment or the second embodiment will be omitted and only portions having different configurations will be described.

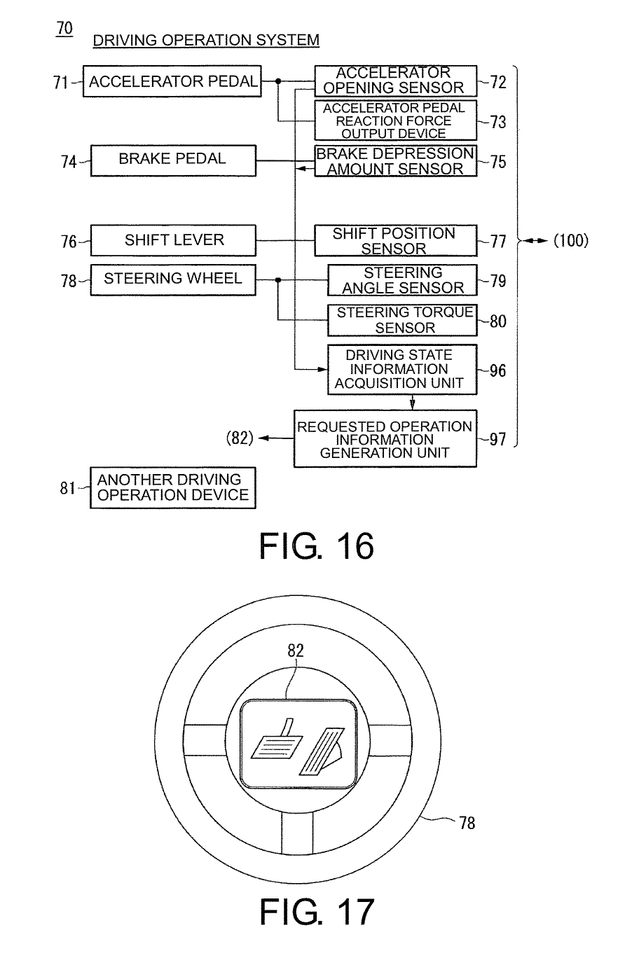

FIG. 16 is a configuration diagram of a function of the driving operation system

The HMI 70 includes, for example, an accelerator pedal 71, an accelerator opening sensor 72, an accelerator pedal reaction force output device 73, a brake pedal 74, a brake depression amount sensor (or, for example, a master pressure sensor) 75, a shift lever 76, a shift position sensor 77, a steering wheel 78, a steering angle sensor 79, a steering torque sensor 80, another driving operation device 81, a driving state information acquisition unit 96, and a requested operation information generation unit 97, as the configuration of the driving operation system.

The driving state information acquisition unit 96 acquires driving state information indicating a state of automatic driving regarding acceleration or deceleration of the vehicle on the basis of performance of a handover event which is an event indicating a transition from automatic driving to manual driving in driving control of the vehicle.

Specifically, for example, if the handover event included in the action plan information 186 created by the action plan generation unit 144 and stored in the storage unit 180 is performed by the automatic driving control unit 120, infoiivation indicating the handover event is output to the driving state information acquisition unit 96 of the HMI 70 via the HMI control unit 170. If the information indicating the handover event is input, the driving state information acquisition unit 96 acquires the driving state information indicating a state of automatic driving regarding acceleration or deceleration of the vehicle. The driving state information is, for example, information including the accelerator opening signal indicating the depression amount or the depression force (operation force) of the accelerator pedal acquired from the accelerator opening sensor 72, and the brake signal indicating the depression amount or the depression force (operation force) of the brake pedal acquired from the brake depression amount sensor 75. According to the by-wire technology or the like, the state of the operation device (for example, a state of the depression amount of the accelerator pedal or the brake pedal) and a control state regarding acceleration and deceleration in automatic driving may not match.

The driving state information acquisition unit 96 outputs the acquired driving state information to the requested operation information generation unit 97.

The handover event may be performed on the basis of the operation of the automatic driving changeover switch 87 to be described below.

The requested operation information generation unit 97 generates requested operation information indicating a notification for causing the transition from automatic driving to manual driving to be smooth on the basis of the driving state information acquired by the driving state information acquisition unit.

Specifically, the requested operation information generation unit 97 generates, for example, requested operation information indicating notification for causing the transition from automatic driving to manual driving to be smooth on the basis of the accelerator opening signal or the brake signal included in the input driving state information. The requested operation information includes, for example, information indicating the notification displayed on the display device 82 illustrated in FIG. 3. The requested operation information generation unit 97 outputs the generated requested operation information to the display device 82.

The display device 82 performs a notification for causing the transition from automatic driving to manual driving to be smoothly performed to the vehicle occupant on the basis of the requested operation information generated by the requested operation information generation unit 97.

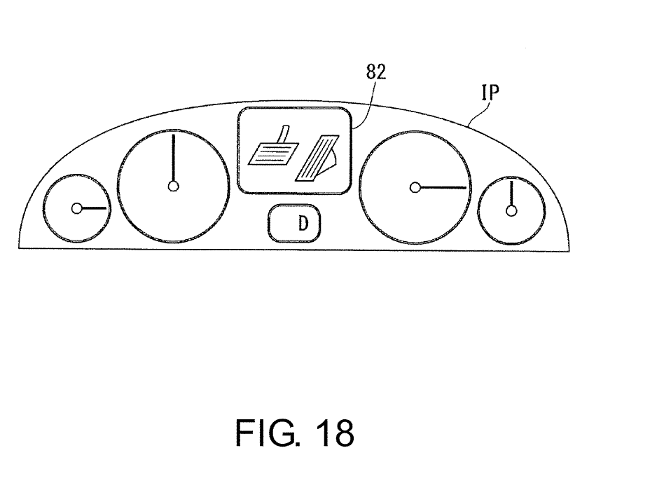

Specifically, the display device 82 is included in, for example, the central portion of the steering wheel 78 as illustrated in FIG. 17 or an instrument panel IP as illustrated in FIG. 18. For example, the display device 82 performs display for notifying the vehicle occupant that the foot should put on the accelerator pedal 71 or the foot should put on the brake pedal 74 on the basis of the requested operation information input from the requested operation information generation unit 97.

The display device 82 may perform display for notifying the vehicle occupant of the depression amount or the depression force (operation force) of the accelerator pedal 71 on the basis of the accelerator opening signal. Further, the display device 82 may perform display for notifying the vehicle occupant of the depression amount or the depression force (operation force) of the brake pedal 74 on the basis of the brake signal.

[Example of Notification to Vehicle Occupant in Transition from Automatic Driving to Manual Driving]

Hereinafter, an example of the notification to the vehicle occupant in the transition from automatic driving to manual driving in the vehicle control system 100 and the HMI 70 according to the third embodiment will be described with reference to the drawings.

FIG. 17 is a diagram illustrating another example of notification of a driving operation for acceleration or deceleration to the vehicle occupant in the display device 82.

As illustrated, a display device 82 is included in a central portion of the steering wheel 78. As described above, the display device 82 is, for example, a display device such as an LCD or an organic EL. In the example illustrated in FIG. 17, an image showing the accelerator pedal and the brake pedal is displayed on the display device 82. In this notification example, the HMI 70 can arbitrarily change the image displayed on the display device 82 on the basis of the driving state information.

For example, the HMI 70 changes the image of the accelerator pedal displayed on the display device 82 to be further prominent on the basis of the accelerator opening signal included in the driving state information. For example, the HMI 70 causes luminance of the image of the accelerator pedal displayed on the display device 82 to be relatively high, or blinkingly displays the image of the accelerator pedal displayed on the display device 82, such that the image of the accelerator pedal is further prominent.

Accordingly, the vehicle occupant can intuitively recognize that the vehicle occupant should put his or her foot on the accelerator pedal 71.

Further, for example, the HMI 70 changes the image of the brake pedal displayed on the display device 82 to be further prominent on the basis of the brake signal included in the driving state information. Accordingly, the vehicle occupant can intuitively recognize that the vehicle occupant should put his or her foot on the brake pedal 74.

The color of the image of the accelerator pedal displayed on the display device 82 and the color of the image of the brake pedal displayed on the display device 82 are different from each other, making it possible for the vehicle occupant to more intuitively determine whether to put the foot on the accelerator pedal 71 or to put the foot on the brake pedal 74.

Further, for example, the HMI 70 may change the image of the accelerator pedal displayed on the display device 82 to indicate a depression amount or a depression force (operation force) of the accelerator pedal 71 on the basis of the accelerator opening signal included in the driving state information. Further, for example, the HMI 70 may change the image of the brake pedal displayed on the display device 82 to indicate a depression amount or a depression force (operation force) of the brake pedal 74 on the basis of the brake signal included in the driving state information.

For example, the HMI 70 causes the image of the accelerator pedal displayed on the display device 82 or the image of the brake pedal displayed on the display device 82 to blink more quickly when the depression amount or the depression force (operation force) of the accelerator pedal 71 or the depression amount or the depression force (operation force) of the brake pedal 74 is larger (or stronger). Accordingly, the vehicle occupant can intuitively recognize the depression amount or the depression force (operation force) of the accelerator pedal 71 or the depression amount or the depression force (operation force) of the brake pedal 74 on the basis of a blinking speed of the image of the accelerator pedal displayed on the display device 82 or the image of the brake pedal displayed on the display device 82, and can smoothly perform takeover of driving behavior associated with the transition from automatic driving to manual driving.

[Another Example of Notification to Vehicle Occupant in Transition from Automatic Driving to Manual Driving]

Hereinafter, another example of the notification to the vehicle occupant in the transition from automatic driving to manual driving in the vehicle control system 100 and the HMI 70 according to the third embodiment will be described with reference to the drawings.

FIG. 18 is a diagram illustrating another example of notification of a driving operation for acceleration or deceleration to the vehicle occupant in the display device 82.

As illustrated, a display device 82 is included in a central portion of the instrument panel IP. As described above, the display device 82 is, for example, a display device such as an LCD or an organic EL. In the example illustrated in FIG. 18, an image showing the accelerator pedal and the brake pedal is displayed on the display device 82. In this notification example, the HMI 70 can arbitrarily change the image displayed on the display device 82 on the basis of the driving state information.

The configuration and the function of the display device 82 illustrated in FIG. 18 and effects from the display device 82 are the same as in the case of the display device illustrated in FIG. 17 described above (the case in which the display device 82 is installed in a central portion of the steering wheel 78)

As described above, according to the vehicle control system 100 and the HMI 70 according to the third embodiment, it is possible to prompt smooth takeover of driving behavior of the driver. Further, according to the vehicle control system 100 and the HMI 70 according to the third embodiment, a state of a specific depression amount or depression force (operation force) of the accelerator pedal or the brake pedal can be recognized. Further, according to the vehicle control system 100 and the HMI 70 according to the third embodiment, whether the foot should be put on the accelerator pedal or whether the foot should be put on the brake pedal can be intuitively recognized. Further, according to the vehicle control system 100 and the HMI 70 according to the third embodiment, a specific depression amount or depression force (operation force) to depress the accelerator pedal or the brake pedal can be recognized.

Although the embodiments of the present invention have been described in detail, a specific configuration is not limited to the above-described configurations, and various design changes can be performed without departing from the gist of the present invention.

For example, the configuration may be a configuration in which the requested operation information notification unit 98a according to the first embodiment, the requested operation information notification unit 98b or the requested operation information notification unit 98c according to the second embodiment, and the display device 82 according to the third embodiment described above are arbitrarily combined.

The vehicle control system 100 and the HMI 70 according to this embodiment in the above-described embodiments may be partially or entirely realized by a computer. In this case, the vehicle control system 100 and the HMI 70 may be realized by recording a program for realizing a control function thereof on a computer-readable recording medium, loading the program recorded on the recording medium into a computer system, and executing the program.

Here, the “computer system” is a computer system built into the vehicle control system 100 and the HMI 70 according to this embodiment, and includes an OS or hardware such as a peripheral device. Further, the “computer-readable recording medium” refers to a portable medium such as a flexible disk, a magneto-optical disc, a ROM, or a CD-ROM, or a storage device such as a hard disk built into a computer system.

Further, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system including a server and a client in such a case. Further, the program may be a program for realizing some of the above-described functions or may be a program capable of realizing the above-described functions in combination with a program previously stored in the computer system.

Further, the vehicle control system 100 and the HMI 70 according to this embodiment in the above-described embodiments may be realized as an integrated circuit through large scale integration (LSI). Respective functional blocks of the vehicle control system 100 and the HMI 70 according to this embodiment may be individually realized as a processor, or some or all of the functional blocks may be integrated and realized as a processor. Further, a scheme of realization as an integrated circuit is not limited to LSI and the functional blocks may be realized as a dedicated circuit or a general-purpose processor. Further, when a circuit integration technology substituting for LSI emerges due to advances in semiconductor technology, an integrated circuit according to the technology may be used.

What is claimed is:

1. A vehicle control system, comprising:
a driving state information acquisition unit that acquires driving state information indicating a state of automatic driving regarding at least one of steering and acceleration/deceleration when a transition from automatic driving to manual driving occurs;
a requested operation information generation unit that generates requested operation information indicating operation information that is requested to a vehicle occupant when the transition from automatic driving to manual driving occurs on the basis of the driving state information acquired by the driving state information acquisition unit; and
a requested operation information notification unit that issues a notification to the vehicle occupant on the basis of the requested operation information generated by the requested operation information generation unit.

2. The vehicle control system according to claim 1,
wherein the driving state information acquisition unit acquires a state of automatic driving regarding steering, and
the requested operation information notification unit displays a position at which the steering wheel is to be gripped on the basis of the state of the automatic driving regarding the steering.

3. The vehicle control system according to claim 1,
wherein the driving state information acquisition unit acquires a state of automatic driving regarding steering, and
the requested operation information notification unit performs display regarding an operation force of the steering wheel on the basis of the state of the automatic driving regarding the steering.

4. The vehicle control system according to claim 2,
wherein the driving state infoiination acquisition unit acquires a state of automatic driving regarding steering, and
the requested operation information notification unit performs display regarding an operation force of the steering wheel on the basis of the state of the automatic driving regarding the steering.

5. The vehicle control system according to claim 1,
wherein the driving state information acquisition unit acquires a state of automatic driving regarding acceleration and deceleration, and
the requested operation information notification unit performs display showing a pedal of which an operation is requested, on the basis of the state of the automatic driving regarding the acceleration and deceleration.

6. The vehicle control system according to claim 2,
wherein the driving state information acquisition unit acquires a state of automatic driving regarding acceleration and deceleration, and
the requested operation information notification unit performs display showing a pedal of which an operation is requested, on the basis of the state of the automatic driving regarding the acceleration and deceleration.

7. The vehicle control system according to claim 3,
wherein the driving state information acquisition unit acquires a state of automatic driving regarding acceleration and deceleration, and
the requested operation information notification unit performs display showing a pedal of which an operation is requested, on the basis of the state of the automatic driving regarding the acceleration and deceleration.

8. The vehicle control system according to claim 4,
wherein the driving state information acquisition unit acquires a state of automatic driving regarding acceleration and deceleration, and
the requested operation information notification unit performs display showing a pedal of which an operation is requested, on the basis of the state of the automatic driving regarding the acceleration and deceleration.

9. The vehicle control system according to claim 1,
wherein the driving state infoiination acquisition unit acquires a state of automatic driving regarding acceleration and deceleration, and
the requested operation infonnation notification unit performs display showing an operation force of a pedal on the basis of the state of the automatic driving regarding the acceleration and deceleration.

10. The vehicle control system according to claim 2,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

11. The vehicle control system according to claim 3,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

12. The vehicle control system according to claim 4,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

13. The vehicle control system according to claim 5,
wherein the driving state information acquisition unit acquires a state of automatic driving regarding acceleration and deceleration, and
the requested operation infonnation notification unit performs display showing an operation force of a pedal on the basis of the state of the automatic driving regarding the acceleration and deceleration.

14. The vehicle control system according to claim 6,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

15. The vehicle control system according to claim 7,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

16. The vehicle control system according to claim 8,
wherein the driving state information acquisition unit acquires a state of automatic driving regarding acceleration and deceleration, and
the requested operation information notification unit performs display showing an operation force of a pedal on the basis of the state of the automatic driving regarding the acceleration and deceleration.

17. A vehicle control method using a computer, the method comprising:
a driving state information acquisition step of acquiring, by a driving state information acquisition unit, driving state information indicating a state of automatic driving regarding at least one of steering and acceleration/deceleration when a transition from automatic driving to manual driving occurs;
a requested operation information generation step of generating, by a requested operation information generation unit, requested operation information indicating operation information that is requested to a vehicle occupant when the transition from automatic driving to manual driving occurs on the basis of the driving state information acquired by the driving state information acquisition unit; and
a requested operation information notification step of issuing, by a requested operation information notification unit, a notification to the vehicle occupant on the basis of the requested operation infonnation generated by the requested operation information generation unit.

18. A vehicle control program product comprising a computer usable medium having control logic stored therein for causing a computer to execute:
a driving state information acquisition step of acquiring driving state information indicating a state of automatic driving regarding at least one of steering and acceleration/deceleration when a transition from automatic driving to manual driving occurs;
a requested operation information generation step of generating requested operation information indicating operation information that is requested to a vehicle occupant when the transition from automatic driving to manual driving occurs on the basis of the driving state information acquired in the driving state information acquisition step; and
a requested operation information notification step of issuing a notification to the vehicle occupant on the basis of the requested operation information generated in the requested operation information generation step.
